(19) United States
(12) Patent Application Publication
(10) Pub. No.: US 2026/0186113 A1
(43) Pub. Date: Jul. 2, 2026

(54) Radio Wave Transmissivity of Printed Heaters

(71) Applicant: Illinois Tool Works Inc., Glenview, IL (US)

(72) Inventors: Edward Mehall, Geneva, IL (US); Piotr Sliwa, Arlington Heights, IL (US); Scott Bair, Skokie, IL (US); Fredrik Andersson, Vasteras (SE); Zsolt Wilke, Bad Mergentheim (DE)

(21) Appl. No.: 19/383,898

(22) Filed: Nov. 10, 2025

Related U.S. Application Data
(60) Provisional application No. 63/728,388, filed on Dec. 5, 2024.
(60) Provisional application No. 63/750,357, filed on Jan. 28, 2025.
(60) Provisional application No. 63/755,795, filed on Feb. 7, 2025.
(60) Provisional application No. 63/788,956, filed on Apr. 15, 2025.

(51) Int. Cl. G01S 7/497; H01Q 1/02; H01Q 1/38; H05B 3/22

(52) U.S. Cl. CPC G01S 7/497; H01Q 1/02; H01Q 1/38; H05B 3/22; G01S 2007/4977; H05B 2203/02; H05B 2214/02

(57) ABSTRACT

Disclosed is a heater array for heating a sensor payload in a vehicle, the heater array being positioned directly over a sensor area of the sensor payload along the path of the sensed energy. This configuration provides direct heating of the sensor area, minimizing the energy required to prevent snow or ice accumulation while reducing interference with the operation of the sensor payload.

### RELATED APPLICATIONS

The present application claims priority to United States Provisional Patent Application Nos. 63/728,388, filed Dec. 5, 2024, 63/750,357, filed Jan. 28, 2025, 63/755,795, filed Feb. 7, 2025, and 63/788,956, filed Apr. 15, 2025, each of which is entitled “Radio Wave Transmissivity of Printed Heaters” and is hereby incorporated by reference in its entirety.

### BACKGROUND

Antenna arrays used in vehicles, including radar systems and other sensors, can experience performance degradation due to the accumulation of snow, ice, or frost on their surfaces. Such buildup obstructs the transmission and reception of electromagnetic signals, reducing the effectiveness and reliability of the systems. Conventional heating solutions may mitigate environmental accumulation but often interfere with the electromagnetic properties of the antenna, causing undesirable effects such as signal attenuation, scattering, or reflection. Accordingly, there exists a need for a heater array that effectively removes environmental obstructions while maintaining the optimal electromagnetic performance of the antenna array.

The present disclosure addresses these challenges by providing a heater array positioned above the antenna array, configured to remove snow and ice without materially affecting the antenna array's electromagnetic performance.

### SUMMARY

The present disclosure relates generally to a heater array, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a vehicle having one or more sensor systems.

FIG. 1b illustrates an assembly view of an example sensor system with heater traces arranged to form a heater array and antenna traces arranged to form an antenna array.

FIGS. 1c through 1g illustrate examples arrangements of heater traces relative to antenna traces.

FIG. 2a illustrates an example sensor system with an antenna array in accordance with an aspect of this disclosure.

FIG. 2b illustrates a heater assembly with a heater array in accordance with an aspect of this disclosure positioned over the sensor system of FIG. 2a.

FIG. 3a illustrates an example sensor system with an antenna array in accordance with another aspect of this disclosure.

FIG. 3b illustrates a heater assembly with a heater array in accordance with another aspect of this disclosure positioned over the sensor system of FIG. 3a.

FIGS. 4a through 4l illustrate heater assemblies with example heater arrays in accordance with other aspects of this disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a heater array for removing snow and ice from an antenna array. This disclosure addresses the challenges of snow and ice removal from antenna arrays by providing a heater array positioned over the antenna array. The heater array is configured with conductive traces patterned to minimize interference with electromagnetic signals, while delivering efficient and uniform heating. The traces are integrated onto a substrate that is transparent to the antenna's operating frequency, ensuring seamless functionality. This disclosure incorporates material and structural optimizations to ensure compatibility with the antenna's operational frequency, durability in harsh environments, and efficient energy use.

In one example, a sensor system comprises: an antenna array configured to transmit or receive sensor energy through a window area; and a heater array positioned over the antenna array within the window area, the heater array comprising a plurality of heater traces configured to generate heat when a current is passed through the plurality of heater traces, wherein each of the plurality of heater traces crosses the antenna array at a trace-crossing transversely.

In some examples, at least one of the plurality of heater traces crosses the antenna array at the trace-crossing perpendicularly.

In some examples, at least one of the plurality of heater traces crosses the antenna array at the trace-crossing at an angle between 45 and 90 degrees.

In some examples, at least one of the plurality of heater traces crosses the antenna array at the trace-crossing at an angle between 60 and 90 degrees.

In some examples, at least one of the plurality of heater traces crosses the antenna array at the trace-crossing at an angle between 75 and 90 degrees.

In some examples, at least one of the plurality of heater traces crosses the antenna array at the trace-crossing at an angle between 80 and 90 degrees.

In some examples, at least one of the plurality of heater traces crosses the antenna array at the trace-crossing at an angle between 85 and 90 degrees.

In some examples, at least one of the plurality of heater traces crosses the antenna array at the trace-crossing at an angle of about 90 degrees.

In some examples, the heater array is applied to a heater substrate to define a camera glare shield.

In some examples, the antenna array is a circular polarized antenna array.

In some examples, the plurality of heater traces is arranged to define a helical portion or a spiral portion.

In some examples, the antenna array is a linear polarized antenna array.

In some examples, the trace-crossing is positioned at or near the midpoint of the antenna trace.

In another example, a heater assembly for removing snow, ice, or debris from an antenna array of a sensor system of a vehicle comprises: a heater substrate positioned over the antenna array; and a plurality of heater traces forming a heater array disposed on or within the heater substrate, wherein the heater traces are arranged to intersect with antenna traces of the antenna array at angles selected to minimize interference with electromagnetic signals transmitted or received by the antenna array, wherein the heater substrate is transmissive to electromagnetic signals of the antenna array, and wherein the heater traces are configured to generate heat when electrical current is applied to the heater traces to remove snow, ice, or debris from a window area of the sensor payload without substantially degrading the performance of the antenna array.

In some examples, the heater traces are arranged in a high-frequency transparent grid or mesh pattern, the pitch of the grid being smaller than the wavelength of the antenna array.

In some examples, the heater traces intersect the antenna traces at perpendicular or transverse angles relative to the polarization direction of the antenna array.

In some examples, the heater traces extend along linear, curved, lobed, or ring-shaped portions of the heater substrate to accommodate the shape of the antenna array and provide uniform heating.

In some examples, the antenna array comprises antenna traces extending radially from a center point,

In some examples, the heater traces are aligned to intersect the antenna traces at trace-crossings at or near the midpoint of the antenna traces.

In some examples, the heater traces are coated with a protective layer that is water-resistant or water-repellent.

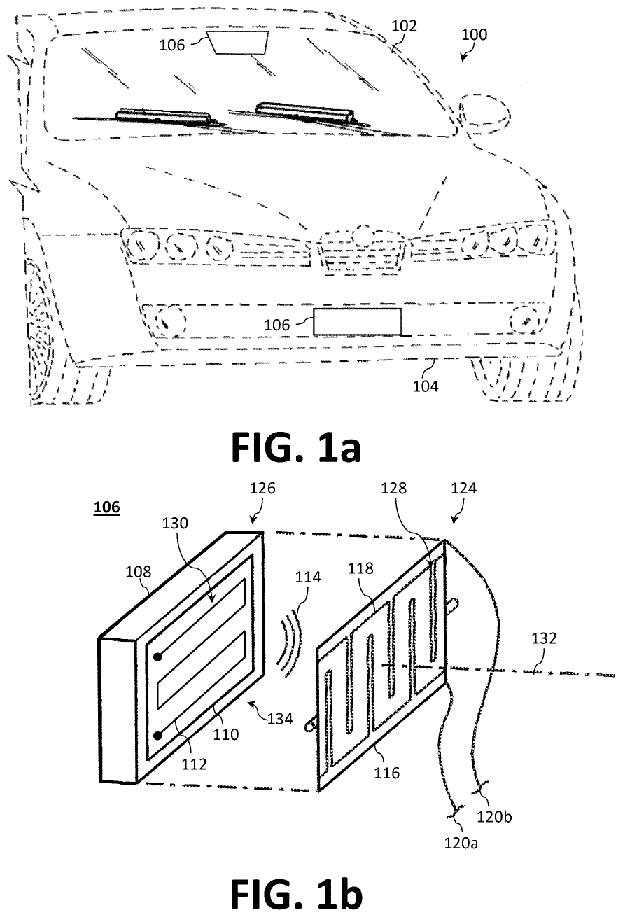

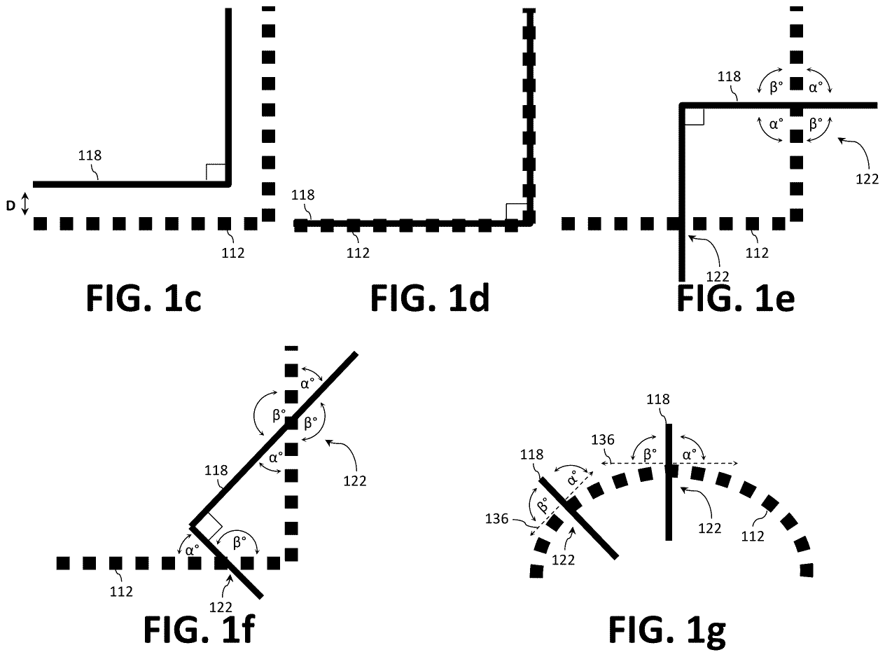

FIG. 1a illustrates a vehicle 100 having one or more sensor systems 106. As shown, the vehicle 100 includes a windshield 102, a bumper 104, and one or more sensor systems 106 positioned in or on the windshield 102 and/or bumper 104. The sensor systems 106 each comprise a sensor payload 126 configured to monitor aspects of the environment surrounding the vehicle 100, such as obstacles, distances, traffic signs, and markings. In some examples, the sensor payload 126 includes an antenna array 130.

FIG. 1b illustrates an assembly view of an example sensor system 106, including the sensor payload 126, a plurality of antenna traces 112 forming an antenna array 130, and a heater assembly 124 with a plurality of heater traces 118 forming a heater array 128. The sensor payload 126 can exchange electrical signals with a sensor interface circuit, which in turn communicates with a vehicular computer. The vehicular computer manages vehicle control tasks such as steering, braking, and engine acceleration. Additionally, the sensor payload 126 communicates with vehicle cockpit display systems to provide information to occupants.

With reference to FIG. 1b, the antenna traces 112 can be printed onto or otherwise adhered to an antenna substrate 110 (e.g., a printed circuit board (PCB)), increasing the structural integrity of the antenna array 130. The antenna substrate 110, along with the antenna array 130, can be attached to a sensor housing 108 (e.g., a rigid plastic component), defining the sensor payload 126. The sensor housing 108 may include mounting elements for securing the sensor payload in a predetermined orientation with respect to the vehicle 100 and providing environmental sealing.

During operation, the sensor payload 126 includes a window area 134 through which it transmits and/or receives sensor energy 114 (e.g., electromagnetic signals) relative to the vehicle 100 along a sensing axis 132. The front-facing sensor payloads 126 may provide a 77-gigahertz long-range radar system with a sensing capability of 1 to 120 meters. Additionally, or alternatively, the front-facing sensor payloads 126 may include far-infrared (night vision) imaging sensors (0.2 to 80 meters), visible-light video sensors or LiDAR (up to 280 meters), short-range radar (24 GHZ, 0.2 to 20 meters), and ultrasonic sensors (0.2 to 1.5 meters). Side sensors may also provide short-range radar and ultrasonic sensing.

To reduce electromagnetic interference, the heater traces 118 are arranged in a high-frequency transparent grid or mesh pattern. The pitch of the grid is selected to be significantly smaller than the wavelength of the antenna's operating frequency. For instance, in radar systems operating at 77 GHz (wavelength ˜3.9 mm), the heater traces 118 are spaced with a pitch smaller than 0.5 mm. This ensures the heater traces 118 remain effectively transparent to electromagnetic signals, minimizing reflection, scattering, and attenuation.

If the window area 134 becomes obstructed by snow, ice, or debris, the sensor energy 114 may also be obstructed, rendering the sensor payload 126 inoperative or less effective. The heater assembly 124 is positioned over the window area 134 to mitigate ice and snow accumulation. It is placed between the window area 134 and environmental exposure to ice, sleet, and snow.

The heater assembly 124 comprises a plurality of heater traces 118 forming a heater array 128. The heater traces 118 may be separated from the antenna array 130 by a small air gap or embedded within the radome material of the vehicle 100. This placement enables effective heat transfer while avoiding direct contact with the antenna array 130, preventing electromagnetic interference. The heater substrate 116 of the heater array 128 is selected to have dielectric properties matching or closely aligning with the radome or surrounding materials to prevent impedance mismatches. Structural and material characteristics of the heater traces 118 are designed to avoid resonances within the antenna's operational frequency band. Frequency-selective surfaces (FSS) may be incorporated to enhance frequency transparency while maintaining thermal performance.

In one example, the heater traces 118 are embedded within or printed on a heater substrate 116 that can be made of a low-loss dielectric material such as polyimide, polyethylene terephthalate (PET), or glass with a suitable coating. These materials minimize signal degradation due to their low electromagnetic loss properties. The heater traces 118, designed as conductive elements, generate heat when an electrical current is applied. The heater substrate 116 may be a thin, transmissively transparent, and optically clear polymer. It can also be water-resistant or treated for water repellency, providing environmental protection for the sensor payload 126. Additional transmissive protective housings may be positioned in front of the sensor payloads 126 and/or heater assembly 124 along the sensor energy 114 propagation path.

The heater array 128 can be powered by the electrical system of the vehicle 100, with voltage and current levels optimized to provide effective heating without overloading the system. Integrated temperature sensors monitor surface temperature, dynamically adjusting power to prevent overheating and ensure efficient energy usage. The control system may use pulse-width modulation (PWM) to regulate heating. For example, the heater assembly 124 may receive electrical power through leads 120a, 120b to heat the assembly and melt accumulated sleet, ice, or snow that could obstruct sensor energy 114 transmission or reception. In one embodiment, the heater operates at 15 to 20 watts.

Power is supplied to leads 120a, 120b via a power control circuit, such as a solid-state switching device (e.g., a transistor), which switches a DC voltage based on temperature sensor readings or periodic intervals. In the case of infrared sensors, the heating may be interleaved with sensing intervals to minimize interference. The DC voltage may be floating or tied to the sensor payload 126's operating voltages, such as those used by radiofrequency modulators and demodulation amplifiers in radar systems.

The heater traces 118 are fabricated as thin conductive materials such as Indium Tin Oxide (ITO), silver nanowires, or fine metallic grids. These materials provide excellent transparency to electromagnetic waves while maintaining sufficient resistance for heating. To ensure uniform heating, the heater traces 118 are designed with consistent resistance along their length, preventing localized thermal variations. The heater array 128 may include multiple independent heating zones that can be selectively activated based on snow or ice accumulation levels, improving energy efficiency.

In some examples, the heater traces 118 of the heater assembly 124 are coated on a rear face of the heater substrate 116 as a positive temperature coefficient (PTC) material, which has the property of conducting electricity with a positive temperature coefficient of resistance. A positive temperature coefficient of resistance causes the amount of electrical flow to vary according to the temperature of the material, with increased electrical flow at lower temperatures and decreased electrical flow at higher temperatures. This property allows for a self-regulating temperature of the PTC material when a substantially constant voltage source is applied across it. In one embodiment, the PTC material may comprise an ethylene vinyl acetate copolymer resin with carbon black added.

The PTC material can be rolled and processed until the desired sheet resistivity is achieved. The heater assembly 124 may support interdigitated electrodes that apply voltage across the PTC material, promoting current flow generally along its plane. Electrodes may be, for example, screen-printed using conductive metallic inks, vapor-deposited (e.g., aluminum or similar materials), applied as a thin decal, etched from an adhered film using integrated circuit techniques or various other manufacturing processes.

FIGS. 1c through 1g illustrate example arrangements of heater traces 118 relative to antenna traces 112. As illustrated, the heater traces 118 can be configured to run alongside and/or intersect with one or more antenna traces 112 (i.e., cross over) at one or more trace-crossings 122. The angle at which the heater traces 118 intersect with the antenna traces 112 at these trace-crossings 122 affects the transmission of the antenna traces 112. Accordingly, the alignment of the heater traces 118 relative to the antenna traces 112 is managed to avoid substantial overlap with the radiating elements of the antenna and, when possible, to intersect the antenna trace 112 at each trace-crossing 122 at a perpendicular or normal angle (90 degrees) or, at a minimum, at a transverse angle that minimizes overlap with the antenna traces. Additionally, the layout of the heater traces 118 is oriented orthogonally or at an angle relative to the polarization direction of the antenna to reduce polarization mismatch and further mitigate interference.

With reference to FIG. 1c, it can be appreciated that the antenna traces 112 and the heater traces 118 are non-overlapping and separated by a distance (D). In this example, the antenna traces 112 are not obstructed by the heater traces 118; however, the heater traces 118 provide minimal, if any, benefit in clearing the antenna traces 112 of snow and ice, as the distance (D) exceeds the critical distance. Furthermore, depending on the operating frequency of the antenna traces 112, the heater traces 118 could interfere with the antenna traces 112 electromagnetically at this distance (D).

With reference to FIG. 1d, it can be appreciated that the antenna traces 112 and the heater traces 118 are wholly overlapping. In this example, while the heater traces 118 provide the benefit of clearing the antenna traces 112 of snow and ice, but the antenna traces 112 are fully, physically obstructed by the heater traces 118, thus reducing their effectiveness.

With reference to FIG. 1e, the antenna traces 112 and the heater traces 118 intersect at two trace-crossings 122. Notably, the heater trace 118 intersects the antenna trace 112 at a normal angle at each trace-crossing 122. That is, in this example, the angles of intersection (α° and β°) are each 90 degrees. This arrangement provides minimal interference with the operation of the antenna traces 112 while allowing the heater traces 118 to heat the area surrounding the antenna traces 112 to melt away snow and ice.

However, not all antenna arrays 130 are conducive to normal (i.e., 90-degree) crossings of the heater traces 118 at each trace-crossing 122 due to the shape and/or size of the antenna arrays 130, which are often optimized for transmission/reception ability rather than compatibility with heater arrays.

With reference to FIG. 1f, similar to the design of FIG. 1e, the antenna traces 112 and the heater traces 118 intersect at two trace-crossings 122. In this example, however, the heater trace 118 intersects the antenna trace 112 at non-normal transverse angles at each trace-crossing 122. That is, in this example, the angles of intersection (α° and β°) are approximately 45 degrees (α°) and 135 degrees (β°), though other angles are possible. While this arrangement introduces more interference than the design in FIG. 1e, it can be used where a balance must be struck between sensor transmission and heating.

While the above-described antenna traces 112 are generally linear, non-linear antenna traces 112 are also considered, if not expected. With reference to FIG. 1g, the antenna trace 112 is illustrated as a half-circle, while the heater traces 118 are illustrated as linear traces. In this example, the heater traces 118 intersect the antenna trace 112 at two trace-crossings 122, such that the angles at each crossing 122 are normal to the tangent line 136 of the half-circle. That is, in this example, the angles of intersection (α° and β°) are each 90 degrees, though other angles are possible. Therefore, a design consideration is to provide an intersection angle of 90 degrees whenever possible. When that is not feasible, the heater trace 118 should intersect the antenna trace 112 at transverse angles that minimize obstruction.

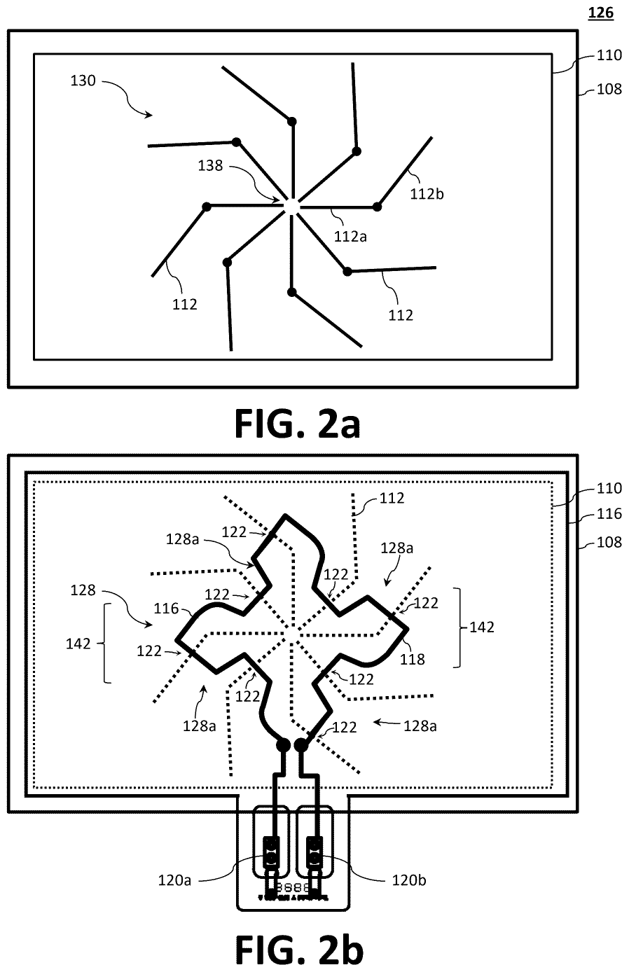

FIG. 2a illustrates an example sensor system 106 with an antenna array 130, while FIG. 2b illustrates a heater assembly 124 with a heater array 128 positioned over the sensor system 106 of FIG. 2a. In FIG. 2b, the heater array 128 is overlaid onto the antenna array 130, which is drawn in broken lines to show its location relative to the heater array 128.

In some examples, the sensor system 106 is part of a Global Navigation Satellite System (GNSS), where the antenna array 130 is positioned behind the heater assembly 124, which is implemented as a heated camera glare shield. In such configurations, the antenna array 130 is designed to receive circularly polarized waves, which are typical for GNSS. To support GNSS and similar systems, the antenna array 130 includes antenna traces 112 that are compatible with circularly polarized waves. Consequently, these antenna traces 112 are not strictly parallel but instead exhibit multiple orientations. The antenna array 130 can therefore be optimized for its specific transmission needs.

In this example, the antenna array 130 comprises a plurality of antenna traces 112 that extend radially from a center point 138. Each of the antenna traces 112 comprises a first linear antenna trace segment 112a and a second linear antenna trace segment 112b connected end-to-end at a transverse angle. They often resemble patterns such as a “star” or a “cross” and may incorporate or define portions similar to a helix or spiral. Due to this multi-directional arrangement of the antenna traces 112, the heating traces of the heater assembly 124 must also adopt mostly nonparallel orientations to align with the design of the antenna array 130. This alignment follows the principles of perpendicularity to nonparallel antenna traces, as discussed in connection with FIGS. 1c through 1g. Furthermore, while this heated camera glare shield is particularly suited for sensor systems 106 operating with circularly polarized waves, it is also designed to be transmissive for other types of sensor systems 106, regardless of whether they utilize linear or circular polarization. Other example sensor systems 106 include, for instance, GMS or Wi-Fi antennas, which typically operate with linear polarization.

To accommodate the shape of this antenna array 130, the heater array 128 is designed accordingly to cross each antenna trace 112 at trace-crossings 122 at a normal angle (perpendicularly), while maintaining electrical continuity along the heater array 128 between leads 120a and 120b. To that end, the heater array 128 is shaped with four lobes 142 spaced apart by linear portions, with each of the four lobes 142 containing a linear portion. As illustrated, the various linear portions are configured to align perpendicularly with the antenna traces 112 at the trace-crossings 122. The remainder of the heater array 128 that does not overlap with the antenna array 130 could include a combination of linear or curved portions as desired to establish conductivity between locations.

As illustrated, the trace-crossings 122 are positioned at or near the midpoint of the antenna trace 112. That is, the trace-crossings 122 are generally centric to the length or extension of the segment of the antenna trace 112 crossed by the heater trace 118 (or portion thereof). Positioning the trace-crossings 122 at the midpoint of a first antenna trace ensures maximum possible separation from a potential second antenna trace portion (e.g., an adjacent section) that may be perpendicular to the first antenna trace. Additionally, this second antenna trace should also be crossed perpendicularly by the heating trace 118, ideally at the midpoint of its length, to maintain optimal signal integrity and heating efficiency.

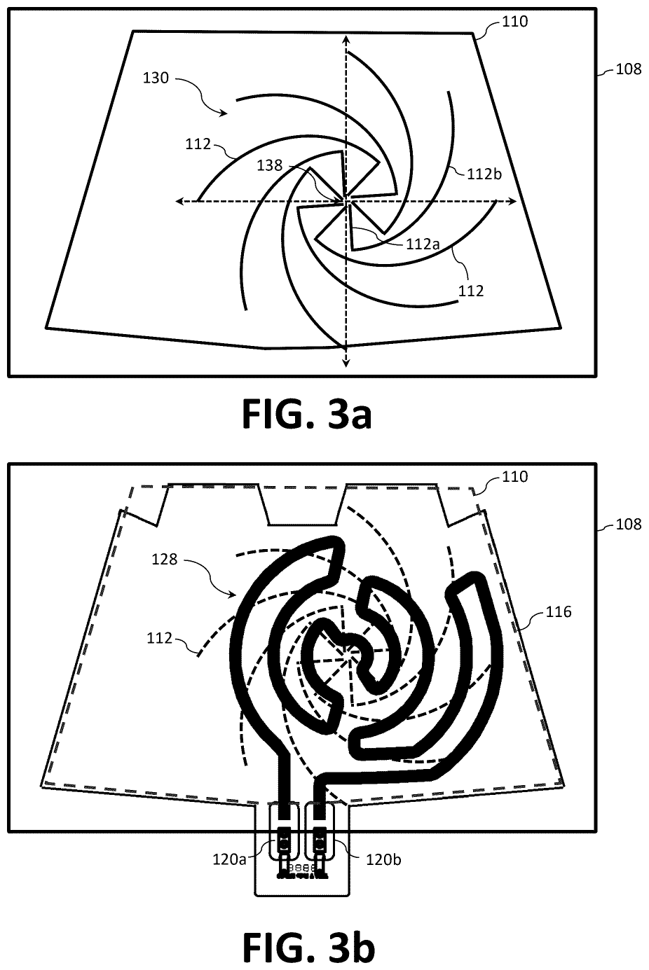

FIG. 3a illustrates another example sensor system 106 with an antenna array 130, while FIG. 3b illustrates a heater assembly 124 with a heater array 128 positioned over the sensor system 106 of FIG. 3a. In this example, the antenna array 130 is not centered relative to the antenna substrate 110 (as indicated by the overlaid axes) in order to, for example, use other parts of the antenna substrate 110 for additional functions (e.g., another antenna or sensor). In FIG. 3b, the heater array 128 is overlaid onto the antenna array 130, which is shown in broken lines to depict its location relative to the heater array 128.

The antenna array 130 comprises a plurality of antenna traces 112 extending radially from a center point 138. In this example, each antenna trace 112 comprises a linear antenna trace segment 112a and a curved antenna trace segment 112b connected end-to-end at a transverse angle (illustrated as approximately 90 degrees). The heater array 128 is shaped with curved portions to accommodate the shape of the antenna traces 112. While the heater array 128 and the antenna traces 112 do not intersect perpendicularly at each trace-crossing 122, the heater trace 118 intersects the antenna trace 112 at transverse angles at various trace-crossings 122.

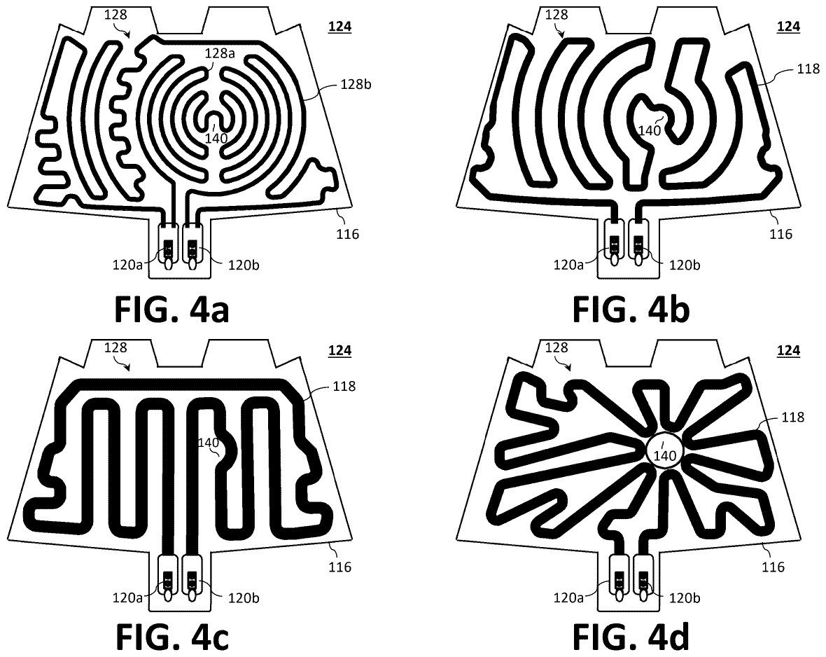

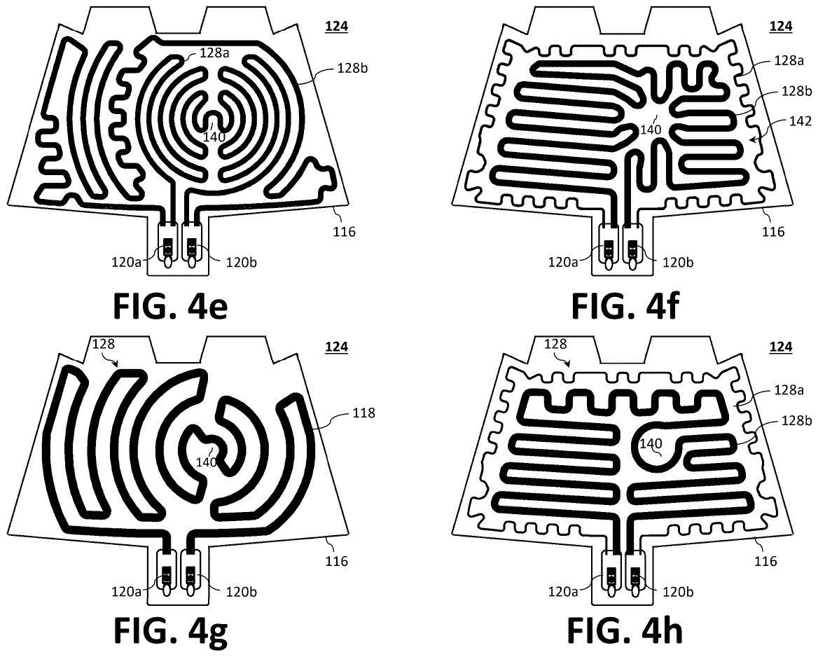

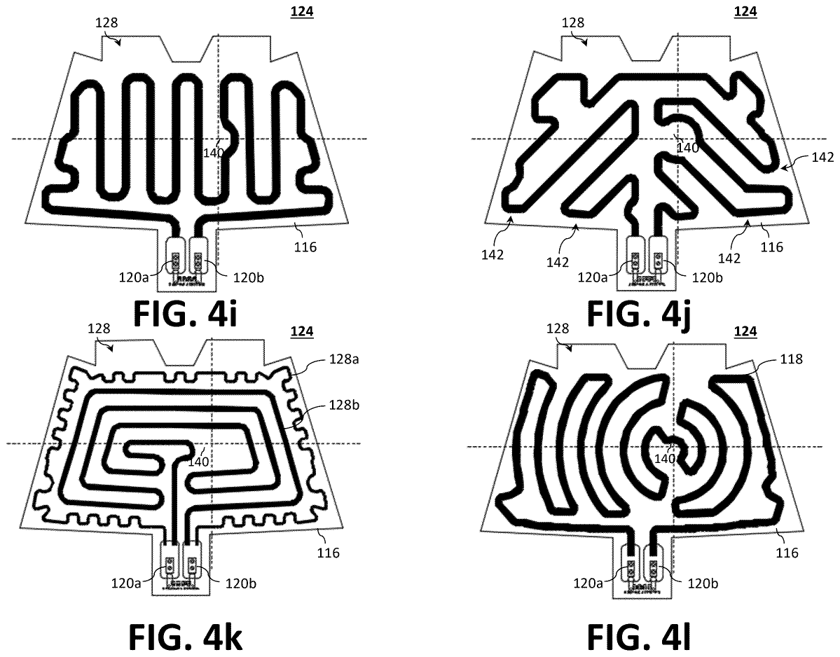

FIGS. 4a through 4l illustrate heater assemblies 124 with example heater arrays 128 in accordance with other aspects of this disclosure. The heater assemblies 124 of FIGS. 4a through 4l can be overlaid onto an antenna array 130, such as the antenna array 130 of FIG. 3 a, though other antenna arrays 130 are contemplated.

FIG. 4a illustrates a heater assembly 124 with two heater arrays 128a, 128b. As illustrated, a first heater array 128a is connected between the leads 120a, 120b and is shaped to define a plurality of rings (or ring portions) that generally corresponds to the location of the antenna array 130. The center of the first heater array 128a includes a void 140 (i.e., an area in the pattern where there is no heater trace 118) that corresponds to the center point 138 of the antenna array 130. The second heater array 128b is also connected between the leads 120a, 120b and is shaped to travel and meander along the outer perimeter of the heater substrate 116. For example, second heater array 128b generally follows the outer perimeter, but zigs and zags to distribute heat more evenly across the area. Given the rather complex pattern provided by the first heater array 128a and second heater array 128b, the width of the heater trace is thinner to avoid interference and allow space for the various heater traces 118.

FIG. 4b illustrates a heater assembly 124 with a single heater array 128 connected between the leads 120a, 120b. The heater array 128 is shaped to define a plurality of rings that generally correspond to the location of the antenna array 130 and to travel and meander along the outer perimeter of the heater substrate 116.

FIG. 4c illustrates a heater assembly 124 with a single heater array 128 connected between the leads 120a, 120b. The heater array 128 is shaped to define a plurality of generally parallel, linear sections that traverse back and forth vertically across the major area of the heater substrate 116, with an additional portion traveling along the outer perimeter of the heater substrate 116. As illustrated, the center of the heater array 128 includes a void 140 that corresponds to the center point 138 of the antenna array 130. Given the simpler pattern provided by the heater array 128 of FIG. 4c, the width of the heater trace 118 is thicker than that of the heater arrays 128 in FIGS. 4 a and 4 b. In this example, apart from the void 140, the heater array 128 is substantially symmetrical across the vertical axis.

FIG. 4d illustrates a heater assembly 124 with a single heater array 128 connected between the leads 120a, 120b. The heater array 128 is shaped to define a plurality of lobes 142 that radiate from a void 140 corresponding to the center point 138 of the antenna array 130. The width of the heater trace 118 is similar to that of the heater array 128 in FIG. 4c.

FIG. 4e is substantially the same as the heater array 128 in FIG. 4a, except that the width of the heater trace 118 is increased.

FIG. 4f illustrates a heater assembly 124 with two heater arrays 128a, 128b. As illustrated, a first heater array 128a is connected between the leads 120a, 120b and is shaped to define a plurality of lobes 142 radiating from a void 140, as well as a series of generally parallel, linear sections that traverse back and forth horizontally across the area of the heater substrate 116 adjacent to the antenna array 130. The second heater array 128b is connected between the leads 120a, 120b and is shaped to travel and meander along the outer perimeter of the heater substrate 116. In this example, the width of the first heater array 128a is less than that of the second heater array 128b.

FIG. 4g is substantially the same as the heater array 128 in FIG. 4b, except that the width of the heater trace 118 is greater.

FIG. 4h illustrates a heater assembly 124 with two heater arrays 128a, 128b. As illustrated, a first heater array 128a is connected between the leads 120a, 120b and is shaped to define a plurality of generally parallel, linear sections that traverse back and forth horizontally across the major area of the heater substrate 116. The second heater array 128b is connected between the leads 120a, 120b and is shaped to travel and meander along the outer perimeter of the heater substrate 116. In this example, apart from the void 140, the heater array 128 is substantially symmetrical across the vertical axis. The width of the first heater array 128a is less than that of the second heater array 128b.

FIG. 4i illustrates a heater assembly 124 with a single heater array 128 connected between leads 120a and 120b. The heater array 128 is shaped to define a series of generally parallel, linear sections that traverse vertically back and forth across the major area of the heater substrate 116, with an additional portion running along the lower perimeter of the heater substrate 116. As shown, the center of the heater array 128 includes a void 140 that corresponds to the center point 138 of the antenna array 130.

FIG. 4j illustrates a heater assembly 124 with a single heater array 128 connected between leads 120a and 120b. The heater array 128 is shaped to define a series of lobes 142 that radiate outward from a void 140 corresponding to the center point 138 of the antenna array 130. The lobes 142 are angled downward, for example, at an angle of approximately 40 to 50 degrees, or about 45 degrees.

FIG. 4k illustrates a heater assembly 124 with two heater arrays, 128a and 128b. As shown, the first heater array 128a is connected between leads 120a and 120b and is shaped to form a series of generally parallel, linear sections that traverse horizontally back and forth across the major area of the heater substrate 116. The second heater array 128b, also connected between leads 120a and 120b, is shaped to meander along the outer perimeter of the heater substrate 116.

FIG. 4l is substantially the same as the heater array 128 in FIG. 4b, except that the heater trace 118 is shaped to include additional traces along the perimeter.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A sensor system comprising:
an antenna array configured to transmit or receive sensor energy through a window area; and
a heater array positioned over the antenna array within the window area, the heater array comprising a plurality of heater traces configured to generate heat when a current is passed through the plurality of heater traces,
wherein each of the plurality of heater traces crosses the antenna array at a trace-crossing transversely.

2. The sensor system of claim 1, wherein at least one of the plurality of heater traces crosses the antenna array at the trace-crossing perpendicularly.

3. The sensor system of claim 1, wherein at least one of the plurality of heater traces crosses the antenna array at the trace-crossing at an angle between 45 and 90 degrees.

4. The sensor system of claim 1, wherein at least one of the plurality of heater traces crosses the antenna array at the trace-crossing at an angle between 60 and 90 degrees.

5. The sensor system of claim 1, wherein at least one of the plurality of heater traces crosses the antenna array at the trace-crossing at an angle between 75 and 90 degrees.

6. The sensor system of claim 1, wherein at least one of the plurality of heater traces crosses the antenna array at the trace-crossing at an angle between 80 and 90 degrees.

7. The sensor system of claim 1, wherein at least one of the plurality of heater traces crosses the antenna array at the trace-crossing at an angle between 85 and 90 degrees.

8. The sensor system of claim 1, wherein at least one of the plurality of heater traces crosses the antenna array at the trace-crossing at an angle of about 90 degrees.

9. The sensor system of claim 1, wherein the heater array is applied to a heater substrate to define a camera glare shield.

10. The sensor system of claim 1, wherein the antenna array is a circular polarized antenna array.

11. The sensor system of claim 10, wherein the plurality of heater traces is arranged to define a helical portion or a spiral portion.

12. The sensor system of claim 1, wherein the antenna array is a linear polarized antenna array.

13. The sensor system of claim 1, wherein the trace-crossing is positioned at or near a midpoint of an antenna trace of the antenna array.

14. A heater assembly for removing snow, ice, or debris from an antenna array of a sensor system of a vehicle, the heater assembly comprising:
a heater substrate positioned over the antenna array; and
a plurality of heater traces forming a heater array disposed on or within the heater substrate,
wherein the heater traces are arranged to intersect with antenna traces of the antenna array at transverse angles,
wherein the heater substrate is transmissive to electromagnetic signals of the antenna array, and
wherein the heater traces are configured to generate heat when electrical current is applied to the heater traces to heat a window area of a sensor payload.

15. The heater assembly of claim 14, wherein the heater traces are arranged in a high-frequency transparent grid or mesh pattern, the pitch of the grid being smaller than the wavelength of the antenna array.

16. The heater assembly of claim 14, wherein the heater traces intersect the antenna traces at perpendicular or transverse angles relative to the polarization direction of the antenna array.

17. The heater assembly of claim 14, wherein the heater traces extend along linear, curved, lobed, or ring-shaped portions of the heater substrate to accommodate a shape of the antenna array and provide uniform heating.

18. The heater assembly of claim 14, wherein the antenna array comprises antenna traces extending radially from a center point.

19. The heater assembly of claim 18, wherein the heater traces are aligned to intersect the antenna traces at trace-crossings at or near a midpoint of the antenna traces.

20. The heater assembly of claim 14, wherein the heater traces are coated with a protective layer that is water-resistant or water-repellent.
